(19) United States
(12) Patent Application Publication
(10) Pub. No.: US 2001/0049801 A1
(43) Pub. Date: Dec. 6, 2001

(54) Dual-ported operator control panel with automatic failover

(76) Inventors: Stuart Allen Berke, Westborough, MA (US); Daniel Wissell, Acton, MA (US)

Correspondence Address: CESARI AND MCKENNA, LLP, 88 BLACK FALCON AVENUE, BOSTON, MA, 02210, US

(21) Appl. No.: 09/862,904

(22) Filed: May 22, 2001

Related U.S. Application Data
(60) Provisional application No. 60/206,482, filed on May 23, 2000.

(51) Int. Cl. G06F 11/00

(52) U.S. Cl. 714/10

(57) ABSTRACT

A dual-ported operator control panel (OCP) arrangement provides redundancy and fault tolerance capabilities in a distributed computer system. The arrangement supports the use of multiple OCPs in the computer system, which is preferably a symmetric multiprocessor (SMP) system having a management subsystem. A system control manager (SCM) microcontroller functions as a “master” of the management subsystem. One OCP functions as a primary OCP of the computer system and the others function as standby (or slave) OCPs. Two independent remote SCMs may be coupled to ports of the OCP to maintain communication between the OCP and an SCM in the event of an SCM failure. The OCP performs port arbitration to automatically select an SCM as the OCP “master” via election rules and, thereafter, only allows the elected master port control over light emitting diodes (LEDs) and a display of the OCP.

### CROSS-REFERENCE TO RELATED APPLICATIONS

The present application claims priority from U.S. Provisional Patent Application Ser. No. 60/206,482, which was filed on May 23, 2001, by Stuart Berke and Daniel Wissell for a DUAL-PORTED OPERATOR CONTROL PANEL WITH AUTOMATIC FAILOVER and is hereby incorporated by reference.

### BACKGROUND OF THE INVENTION

1. Field of the Invention

The present invention relates to computer systems and, in particular, to the use of redundancy and fault tolerance in a computer system to ensure minimal down time.

2. Background Information

Redundancy and automatic failover are desired features of a distributed computer system that are employed to ensure that component failures within the computer do not bring down the entire system. However, one component that typically does not have redundant capability is the operator control panel (OCP). The OCP is a fairly small operator area on the front of a computer that allows a user to control basic system states via push buttons and a keyswitch. The push buttons typically comprise halt, reset and fault state buttons whereas the keyswitch may provide states such as off, on and secure. The OCP also allows a user to observe states of the computer system via light emitting diodes (LEDs), such as power OK, halt and secure, and via an ASCII/graphical vacuum fluorescent display (VFD). An object of the present invention described herein is to provide redundant OCP capability in a computer system to reduce down time of the system in the event of failure of an OCP.

The distributed computer system may be managed remotely using a serial line to connect to a “console” or system management port of the computer. The serial line connection typically enables a user (a system operator/manager) to communicate with an operating system or console system software executing on the computer when exchanging system management traffic relating to, e.g., a power subsystem of the computer. This serial connection arrangement is satisfactory when managing a powered on system; however, when the computer is not running, this arrangement is ineffective. Therefore, the computer system may have at least one separately powered service processor that can power on/off the computer and provide access to other computer management information.

For a service processor to become the system management port of the computer it must communicate with the OCP. In particular, the service processor must communicate with the keyswitch of the OCP to be aware of its position in order avoid any safety problems. For instance, if the switch is in the off position the management port must ensure that the system does not power-on, especially for a remotely managed system where a local user/operator may be servicing the computer. To further enhance redundancy and automatic failover of the system, it is desirable to provide an OCP that is capable of supporting at least two service processors so that one service processor is available for communication with the OCP in the event of failure to the other service processors.

### SUMMARY OF THE INVENTION

The present invention comprises a dual-ported operator control panel (OCP) arrangement that provides redundancy and fault tolerance capabilities in a distributed computer system. The arrangement supports the use of multiple OCPs in the computer system, which is preferably a symmetric multiprocessor (SMP) system having a management subsystem comprising a network of microcontrollers that cooperate to gather and maintain configuration information throughout the system. A service processor, such as a system control manager (SCM) microcontroller, functions as a “master” of the management subsystem to control its subordinate “slave” microcontrollers, each of which manages a different subsystem within the SMP system. As described herein, one OCP functions as a primary OCP of the computer system and the others function as standby (or slave) OCPs.

In the illustrative embodiment, the dual-ported OCP arrangement satisfies requirements for providing redundancy in the power control subsystem of the computer. For example, two independent remote SCMs may be coupled, preferably via cables, to ports of the OCP to maintain communication between the OCP and an SCM in the event of an SCM failure. EIA signaling over the cables supports greater than 10-meter cable lengths between the OCP and the remote SCMs. The OCP ports are configured to maintain electrical isolation between the remote SCMs to thereby eliminate ground loops and system noise. This also enables use of the OCP in remotely located, fiber optic interconnected applications. The OCP performs port arbitration to automatically select an SCM as the OCP “master” via election rules and, thereafter, only allows the elected master port control over light emitting diodes (LEDs) and a display of the OCP.

Advantageously, the dual-ported OCP arrangement supports a comprehensive redundant system control management approach for a distributed computer system. Since the SCM controls the power subsystem, redundant SCM capability is needed for high availability. Allowing two SCMs to access a primary OCP supports redundant SCM operation and supports multiple SCM/OCPs for further high availability.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes and an input/output (I/O) subsystem interconnected by a hierarchical switch (HS);

FIG. 2 is a schematic block diagram of a QBB node of FIG. 1;

FIG. 3 is a schematic block diagram of the I/O subsystem of FIG. 1;

FIG. 4 is a schematic block diagram of a console serial bus (CSB) subsystem within the SMP system;

FIG. 5 is a schematic block diagram of various agents, including a system control manager (SCM) coupled to a Peripheral Computer Interconnect (PCI) backplane of a PCI drawer and adapted to communicate with an operator control panel (OCP) that may be advantageously used with the present invention;

FIG. 6 is a schematic block diagram of various agents, including a power system manager (PSM) module, coupled to a QBB backplane of the QBB node of FIG. 2;

FIG. 7 is a schematic block diagram illustrating the interaction between the CSB subsystem and the QBB nodes coupled to the HS of the SMP system;

FIG. 8 is a schematic block diagram of an illustrative embodiment of a dual-ported OCP arrangement in accordance with the present invention;

FIG. 9 is schematic diagram depicting a power conversion circuit within the novel OCP arrangement;

FIG. 10 is a table illustrating various cases for rendering an OCP master determination in accordance with the present invention;

FIG. 11 is a schematic block diagram of a keyswitch used with the dual-ported OCP arrangement in accordance with the invention; and

FIG. 12 is a table illustrating the states of the keyswitch poles with respect to the off, on and secure positions of the switch.

### DETAILED DESCRIPTION OF AN ILLUSTRATIVE EMBODIMENT

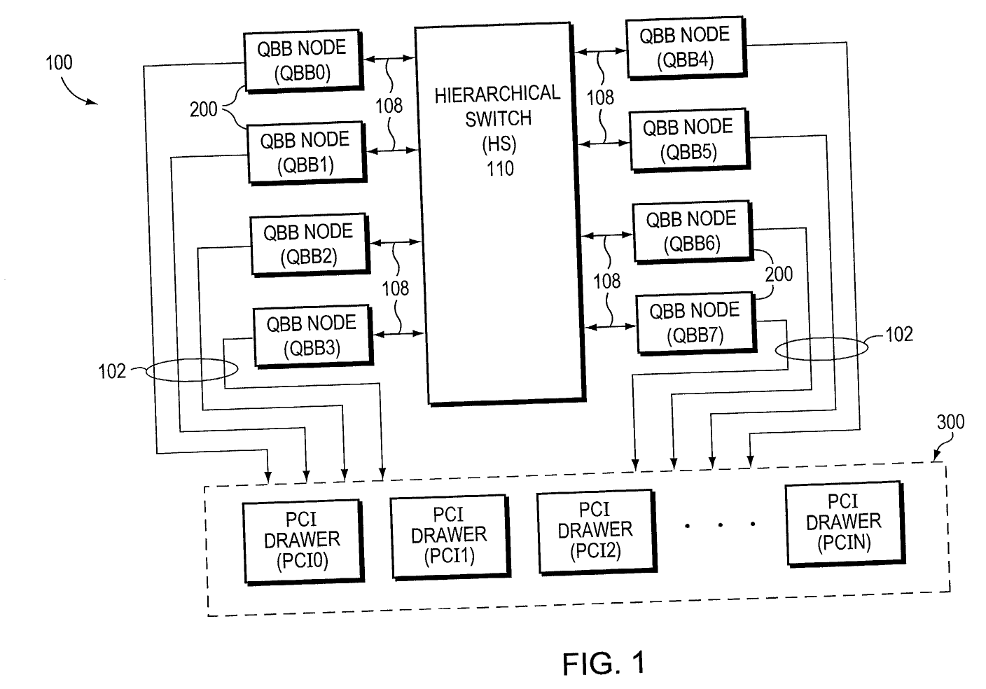

FIG. 1 is a schematic block diagram of a modular, symmetric multiprocessing (SMP) system 100 having a plurality of nodes 200 interconnected by a hierarchical switch (HS) 110. The SMP system also includes an input/output (I/O) subsystem 300 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising, inter alia, a plurality of processors, a plurality of memory modules, a directory, an I/O port (IOP), a plurality of I/O risers, and a global port (GP) interconnected by a local switch. Each memory module may be shared among the processors of a node and, further, among the processors of other QBB nodes configured on the SMP system to create a distributed shared memory environment. A fully configured SMP system preferably comprises eight (8) QBB (QBB0-7) nodes, each of which is coupled to the HS 110 by a full-duplex, bi-directional, clock forwarded HS link 108.

Data is transferred between the QBB nodes 200 of the system 100 in the form of packets. In order to provide the distributed shared memory environment, each QBB node is configured with an address space and a directory for that address space. The address space is generally divided into memory address space and I/O address space. The processors and IOP of each QBB node utilize private hardware caches to store data for memory-space addresses; I/O space data is generally not “cached” in the private caches.

QBB Node Architecture

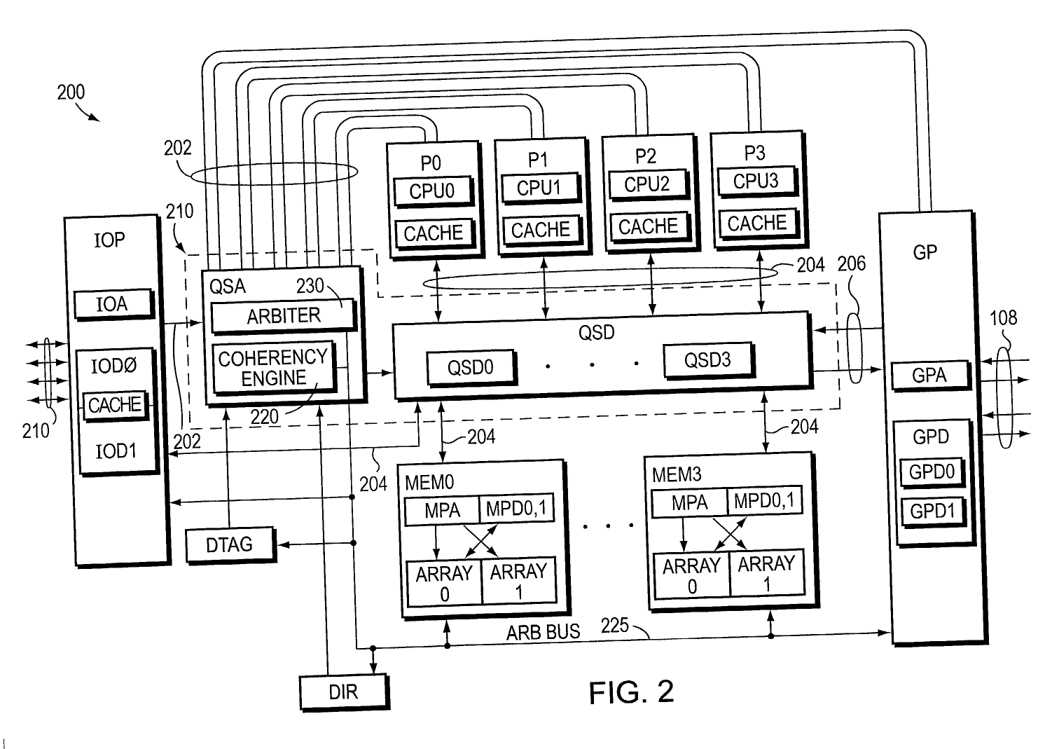

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hose 102. As with the case of the SMP system, data is transferred among the components or “agents” of the QBB node 200 in the form of packets. As used herein, the term “system” refers to all components of the QBB node excluding the processors and IOP.

Each processor is a modern processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation, although other types of processor chips may be advantageously used. The load/store instructions executed by the processors are issued to the system as memory references, e.g., read and write operations. Each operation may comprise a series of commands (or command packets) that are exchanged between the processors and the system.

In addition, each processor and IOP employs a private cache for storing data determined likely to be accessed in the future. These hardware caches are preferably organized as write-back caches apportioned into, e.g., 64-byte cache lines accessible by the processors; it should be noted, however, that other cache organizations, such as write-through caches, may be advantageously used. It should be further noted that memory reference operations issued by the processors are preferably directed to a 64-byte cache line granularity. Since the IOP and processors may update data in their private hardware caches without updating shared memory, a cache coherence protocol is utilized to maintain data consistency among the caches.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 64-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects.

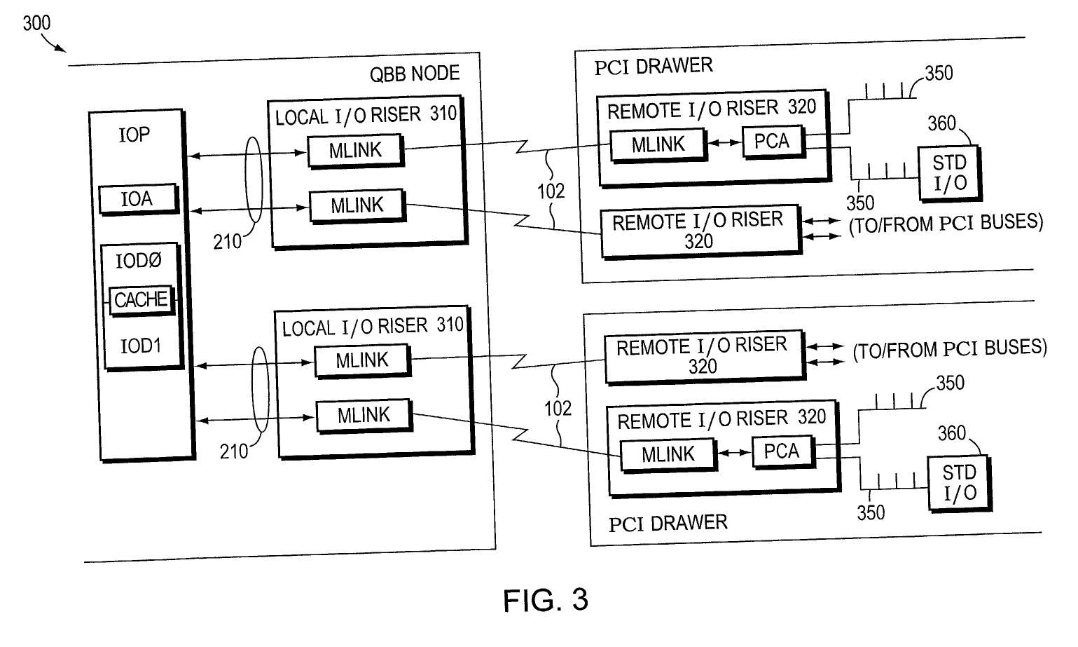

The IOP preferably comprises an I/O address (IOA) ASIC and a plurality of I/O data (IOD0-1) ASICs that collectively provide an I/O port interface from the I/O subsystem to the QBB node. The IOP is connected to a plurality of local I/O risers (FIG. 3) via I/O port connections 210, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS 110 via a set of unidirectional, clock forwarded address and data HS links 108.

A plurality of shared data structures are provided for capturing and maintaining status information corresponding to the states of data used by the nodes of the system. One of these structures is configured as a duplicate tag store (DTAG) that cooperates with the individual hardware caches of the system to define the coherence protocol states of data in the QBB node. The other structure is configured as a directory (DIR) to administer the distributed shared memory environment including the other QBB nodes in the system. The protocol states of the DTAG and DIR are further managed by a coherency engine 220 of the QSA that interacts with these structures to maintain coherency of cache lines in the SMP system 100. That is, the DTAG captures the state for the QBB node coherence protocol, while the DIR captures the coarse state for the SMP system protocol. Each of these structures interfaces with the GP to provide coherent communication between the QBB nodes 200 coupled to the HS 110.

The DTAG, DIR, coherency engine, IOP, GP and memory modules are interconnected by a logical serial bus, hereinafter referred to as an Arb bus 225. Memory and I/O reference operations issued by the processors are routed by an arbiter 230 of the QSA over the Arb bus 225. The coherency engine and arbiter are preferably implemented as a plurality of hardware registers and combinational logic configured to produce sequential logic circuits, such as state machines. It should be noted, however, that other configurations of the coherency engine, arbiter and shared data structures may be advantageously used.

FIG. 3 is a schematic block diagram of the I/O subsystem 300 comprising a plurality of local and remote I/O risers 310, 320 interconnected by I/O hoses 102. The local I/O risers 310 are coupled directly to QBB backplanes of the QBB nodes 200, while the remote I/O risers 320 are contained within PCI drawers of the I/O subsystem. In the illustrative embodiment, each local I/O riser includes two local Mini-Link copper hose interface (MLINK) ASICs that couple the I/O ports 210 to local ends of the I/O hoses. Each local I/O riser 310 is preferably “hot-swappable” and thus includes a presence signal and a storage element used to identify the type of module plugged into an associated I/O riser connector.

Each PCI drawer includes two remote I/O risers 320, each comprising one remote MLINK that connects to a far end of the I/O hose 102. The I/O hose comprises a “down-hose” path and an “up-hose” path to enable a full duplex, flow controlled data path between the PCI drawer and IOP. The remote MLINK also couples to a PCI bus interface (PCA) ASIC that spawns two PCI buses 350, a first having three slots and a second having four slots for accommodating I/O devices, such as PCI adapters. The first slot of first PCI bus is preferably reserved for a standard I/O module 360 described herein.

Console Serial Bus (CSB) Subsystem

The SMP system also includes a console serial bus (CSB) subsystem that manages various power, cooling and clocking sequences of the subsystems within the SMP system in order to, inter alia, discharge system management functions directed to agents or field replaceable units (FRUs) of the system. In particular, the CSB subsystem is responsible for managing the configuration of FRUs within each QBB node and the power-up sequence of those elements, including the HS, handling “hot-swap” of the FRUs, and conveying relevant status and inventory information about the FRUs to designated processors of the SMP system.

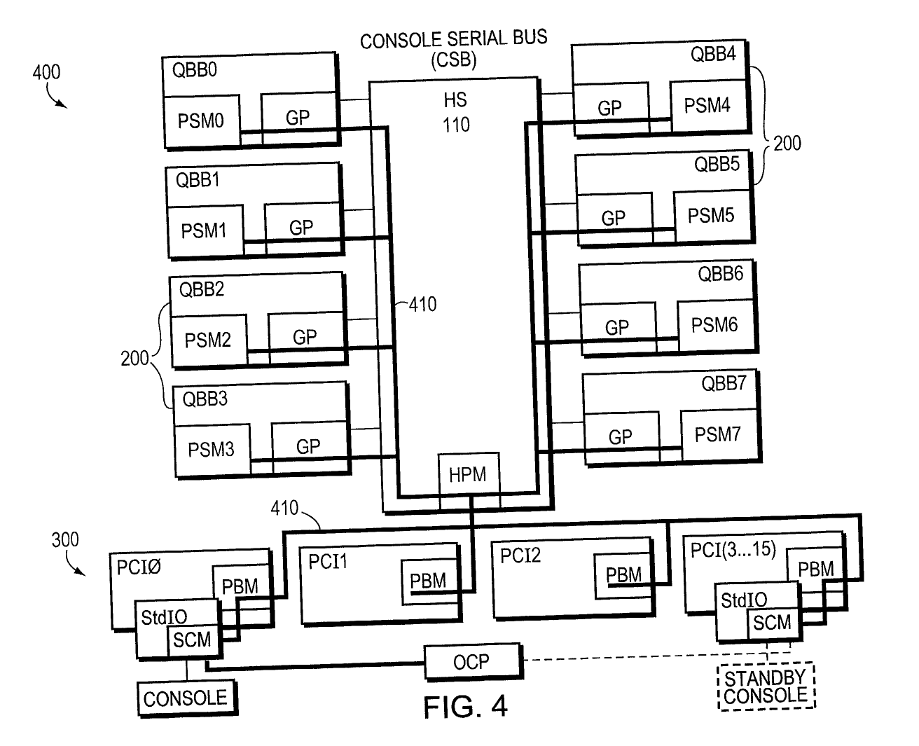

FIG. 4 is a schematic block diagram of the CSB subsystem 400 comprising a CSB bus 410 that extends throughout the SMP system interconnecting each QBB node 200 with the I/O subsystem 300. The CSB bus 410 is preferably a 4-wire interconnect linking a network of microcontrollers located within each PCI drawer and QBB node coupled to the HS 110 of the SMP system 100. The CSB subsystem operates on an auxiliary voltage (V-aux) supply to “bring-up” (power) the microcontrollers of the CSB subsystem to thereby enable communication over the CSB bus 410 in accordance with a serial protocol. An example of a serial protocol that may be advantageously used with the present invention is the transport protocol provided by Cimetrics, Inc. As described herein, the microcontrollers are responsible for gathering and managing configuration information pertaining to each FRU within each subsystem.

The microcontrollers preferably include a power system manager (PSM) residing on a QBB backplane of each node, a HS power manager (HPM) residing on the HS, a PCI backplane manager (PBM) coupled to the PCI backplane of each PCI drawer and at least one system control manager (SCM) of the I/O subsystem. Broadly stated, the SCM interacts with the various microcontrollers of the hardware subsystem 400 in accordance with a master/slave relationship over the CSB bus. For example, the “master” SCM may instruct the “slave” microcontrollers to monitor their respective subsystems to retrieve status information pertaining to the FRUs in order to facilitate system management functions. To that end, microcontrollers (such as the PSM) may provide instructions to other microcontrollers over serial buses in accordance with a master/slave relationship.

As part of its management functions, the SCM provides an operator command line interface (CLI) on local and modem ports of the system, while monitoring operator control panel (OCP) buttons and displaying system state information on light emitting diodes (LEDs) and a display of the OCP. The SCM further provides remote system management functions including system-level environmental monitoring operations and, e.g., power on/off, reset, halt, fault functions associated with the OCP. In addition, the SCM interfaces with a system reference manual (SRM) console application executing on a system processor of a QBB node. The SCM preferably resides on the standard I/O module within a PCI backplane and shares a communication port with the SRM console.

The SRM console operates at a command-level syntax to provide system management functions (such as boot, start-up and shutdown functions). Operating system calls are issued to the SRM console and manifested through a data structure arrangement to enable communication with the SCM. In the illustrative embodiment, the SRM console software interfaces with the CSB hardware subsystem 400 through the SCM and, in particular, through a configuration port of a dual-ported, shared random access memory (RAM) to convey status information to an operating system executing on the processor. The configuration port appears in the address spaces of both the SCM microcontroller and the system processor. The shared RAM allows both entities to efficiently communicate configuration changes by manipulating data structures stored in the shared RAM.

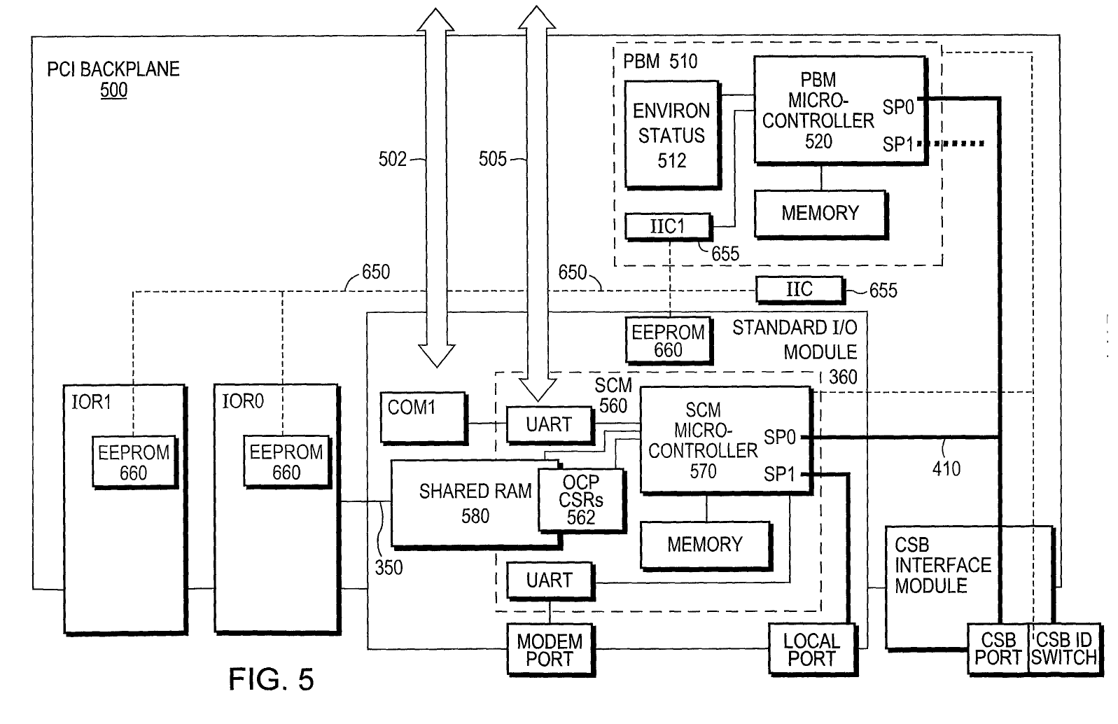

FIG. 5 is a schematic block diagram of various agents coupled to a PCI backplane 500 of a PCI drawer. The PCI backplane 500 accommodates a PBM module 510 and a plurality of remote I/O risers 320 (IOR0,1), each of which connects to an I/O hose 102. As noted, each remote IOR 320 includes a PCI bus interface circuit that spawns two PCI buses 350, a first having three slots and a second having four slots for accommodating I/O devices, such as PCI adapters. The first slot of the first PCI bus is preferably reserved for the standard I/O module 360. Controllers for various load devices, such as floppy and CD disks, are coupled to the standard I/O module 360 over a miscellaneous I/O bus 502. The standard I/O module 360 also comprises a SCM “corner” 560 and the shared RAM 580 for communicating with the SRM console.

In the illustrative embodiment, each SCM and PBM comprises an AM186ES microcontroller and various memories. The SCM 560 further includes control status registers (CSRs) 562 for communicating with the OCP, along with universal asynchronous receivers and transceiver (UART) circuitry for communicating with various devices in the system over, e.g., bus 505. The PBM 510, on the other hand, includes a data structure 512 configured to accommodate environmental status control parameters. As noted, the SCM microcontroller 570 functions as a master microcontroller when communicating with the slave microcontrollers over the CSB bus 410 to manage the CSB subsystem 400. As part of its CSB management function, the SCM 570 interfaces to the CSB bus 410 to interrogate those environmental parameters in order to determine their status.

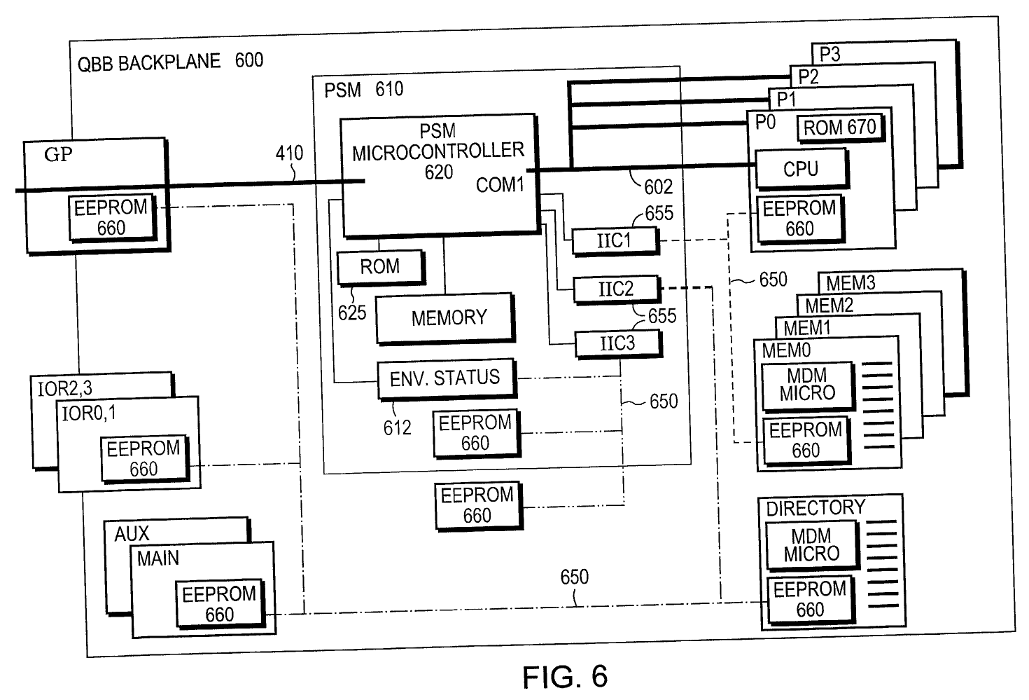

FIG. 6 is a schematic block diagram of various FRUs of a QBB node, including a QBB backplane 600. The QBB backplane 600, in turn, supports a plurality of FRUs including processor modules (P0-3), memory modules (MEM0-3), a directory module (DIR), main/auxiliary power modules (MAIN/AUX), local I/O riser modules (IOR0-3), a GP module and a PSM module 610. In the illustrative embodiment, the PSM module comprises an AM186ES microcontroller 620, various memories and a data structure 612 for storing environmental control parameters.

In addition, the PSM microprocessor 620 includes at least one communication port coupled to a serial bus 602 that interfaces to each processor module of the QBB node 200. During a “boot” process for each processor, the PSM 620 exchanges command/status information with the CPU of each processor module over the serial bus 602. For example, the PSM provides commands to the CPU instructing that processor to execute certain self-tests and, upon completion of the tests, the CPU returns their status to the PSM where they are forwarded over the CSB bus 410 to the SCM 570. The SCM 570 thus has a complete view of the agents of each QBB node 200 prior to booting the SRM console and operating system.

The PSM 610 is generally responsible for powering-up the FRUs of the QBB node, along with managing their self-tests and their populations. To that end, the PSM performs inventory control functions, including gathering of configuration information, such as presence of FRUs in the subsystem. This configuration information may be acquired by the microcontrollers during V-aux and stored in internal registers of the PSM. The presence information is preferably loaded into the internal registers via out-of-band wires that are hardwired to the QBB backplane of the QBB node. The PSM examines the states of those internal registers to determine which FRUs are present in its subsystem.

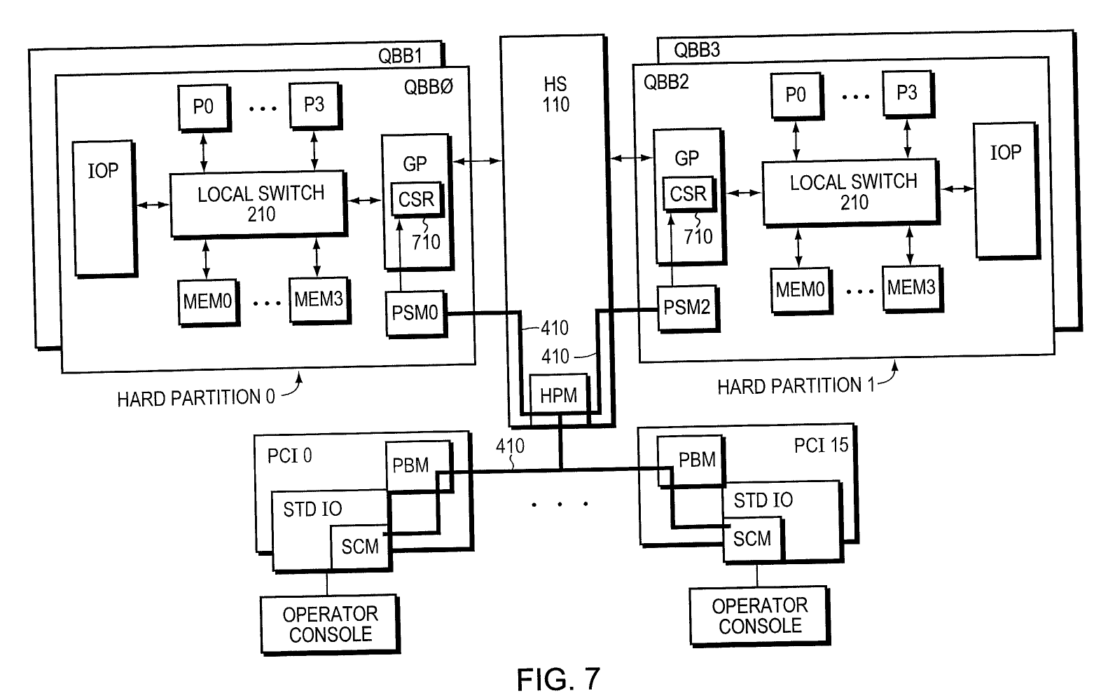

FIG. 7 is a schematic block diagram illustrating the interaction between the CSB subsystem and the QBB nodes coupled to the HS of the SMP system. A hard partition comprises a group of hardware resources (processors, memory and I/O) that is organized as an address space having an instance of an operating system executing thereon. In an embodiment of the present invention, the QBB nodes may be organized into hard partitions and the CSB subsystem provides a means for communicating among those hard partitions. Each hard partition includes a standard I/O module and a SCM microcontroller that manages the CSB subsystem by, in part, communicating with the OCP.

Dual-Ported OCP Arrangement

The present invention is directed to a dual-ported OCP arrangement that provides redundancy and fault tolerance capabilities in the SMP system. The arrangement supports the use of multiple OCPs in the system, wherein one OCP functions as a primary OCP of the SMP system (or partition) and the others function as standby (or slave) OCPs. The dual-ported OCP arrangement also satisfies requirements for providing redundancy in the management subsystem of the SMP system. For example, two independent remote SCMs are coupled, preferably via cables, to ports of each OCP to maintain communication between the OCP and an SCM in the event of an SCM failure. EIA signaling over the cables supports greater than 10-meter cable lengths between the OCP and the remote SCMs. As described herein, the OCP ports are configured to maintain electrical isolation between the remote SCMs to thereby eliminate ground loops and system noise. The OCP performs port arbitration to automatically select an SCM as the OCP “master” via novel election rules and, thereafter, only allows the elected master port control over the LEDs and display of the OCP.

In the illustrative embodiment, the SMP system 100 has distributed power domains such that each SCM operates on a power supply that is different from the supplies powering the other SCMs in the system, while the OCP operates on yet a different power supply. Specifically, the OCP receives power from a 48-volt DC output of a system power supply and each SCM is powered by a PCI drawer power supply that derives its power from alternating current. Because of the various power domains in the system, the OCP is electrically isolated from the system to thereby eliminate ground loops and noise. In addition, the electrical signals flowing from each SCM to the OCP are isolated from one another at the OCP. The OCP provides DC-DC opto-isolator converters for generating +5 volts DC for the OCP and vacuum fluorescent display (VFD) logic, as well as two separate, isolated +5 volt DC supplies for the SCM port interface logic.

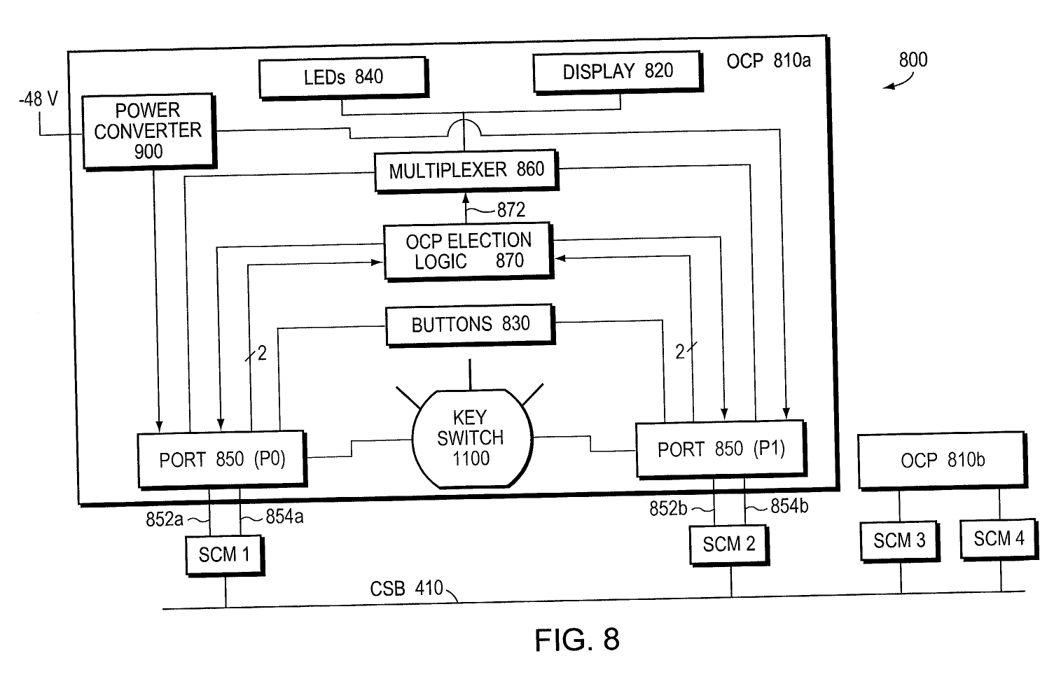

FIG. 8 is a schematic block diagram of the dual-ported OCP arrangement 800 comprising a plurality of OCPs 810, wherein each OCP includes a 4 line by 80 character alphanumeric VFD (display 820) that may be used in graphics mode under control of a microprocessor, such as SCM microcontroller 570. Each OCP 810 also includes push buttons 830 comprising halt, reset and fault state buttons and LEDs 840, such as power OK, halt and secure, that allow a user to observe states of the system 100. The states of the buttons 830 are constantly provided to OCP ports 850 over separate isolated data paths. However, the display 820 and LEDs 840 are controlled by only one of those ports; therefore a multiplexing function is used to control which port has access to that information.

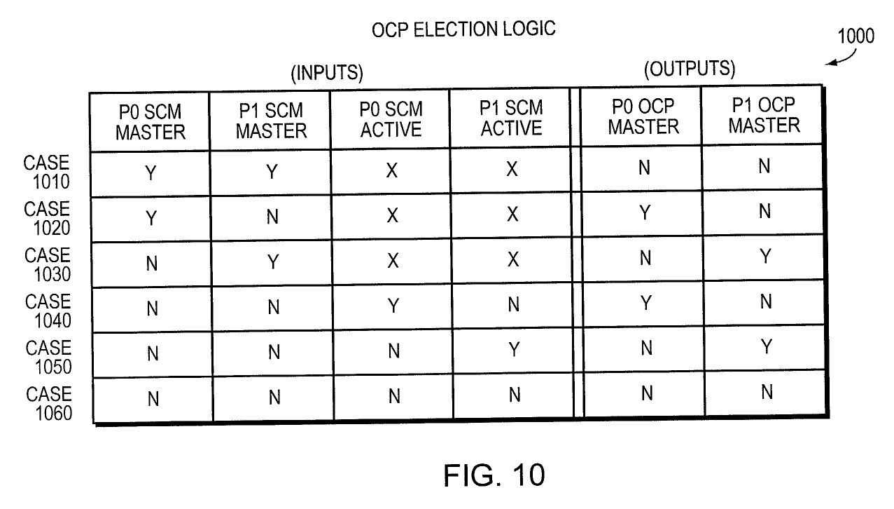

The multiplexing function is preferably embodied as multiplexer 860 and is controlled by OCP election logic 870. The OCP election logic may comprise combinational logic circuitry configured to produce sequential logic circuits and cooperating state machines adapted to implement an OCP Master Determination table 1000 (FIG. 10). Four inputs (two from each opto-isolated port) are used by the OCP election logic 870 to determine which port controls the display and LEDs, while two outputs (one to each port) are provided to those ports to identify which port is the master OCP. Another output from the OCP election logic functions as an enable signal over line 872 to control the multiplexer 860.

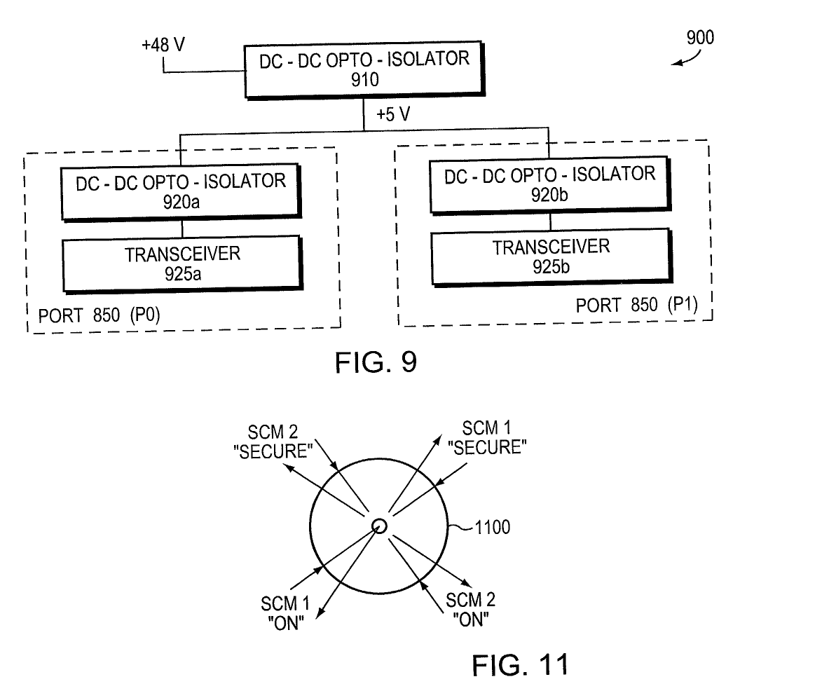

A power conversion circuit 900 within the OCP transforms the output voltage from a 48-volt supply to 5 volts for powering the display and buttons of the OCP. FIG. 9 is schematic diagram of the power converter circuit 900 that comprises a conventional DC-DC opto-isolator 910 adapted to receive, e.g., 48 volts and generate 5 volts of OCP power. The 5 volts power is then applied to two DC-DC opto-isolators 920a, b, each of which is coupled to a RS232 transceiver 925a, b of each OCP port 850. These latter conventional opto-isolators further provide isolated power to the OCP ports, which power is isolated from the 5 volt OCP power.

For most system configurations, a single OCP 810 may be connected to a single SCM 560. However, in order to support redundant SCMs within the SMP system, the OCP also operates in dual-redundant and multiple-OCP redundant modes. In dual-redundant mode, each OCP port 850 is connected to an SCM 560. The OCP monitors a Pn SCMmaster line 852a, b and a Pn SCM active line 854a, b extending from each SCM in order to select one port as an “active master” port. The SCM coupled to the selected master port controls the display 820 on the OCP and illuminates the LEDs 840; display data and LED signals from the non-master SCM port are ignored. If the SCM OCP master port becomes unavailable due to malfunction or power-off, the OCP automatically enables the second port as the new master of the OCP.

In multiple OCP redundant mode, up to eight SCMs 560 may be connected to eight separate OCPs 810 or up to eight SCMs may be connected to four dual-redundant OCPs. The OCP coupled to the master SCM is the primary OCP; all other OCPs are slave OCPs. The slave OCPs generally operate in standby mode. That is, if the master SCM or primary OCP fails, a redundant SCM/OCP assumes the mastership of the OCP to control the CSB management subsystem of the SMP system. Where there are multiple dual-ported OCPs in the system, it is possible that the SCMs coupled to a particular OCP will not assert their master signals over line 852. Nevertheless, the OCP will select one of these two SCMs to control that particular OCP and that SCM is designated the “slave” OCP.

For example, assume SCM3 coupled to OCP 810b is the master SCM of the CSB subsystem 400. The OCP 810b thus becomes the primary OCP of the SMP system and the OCP 810a coupled to SCM1 and SCM2 is a slave OCP (and available for redundancy purposes). OCP 810a still must select between the ports 850 coupling SCM1 and SCM2 as the SCM port designated to control the slave OCP. If the master SCM (e.g., SCM3) fails and re-election among the SCMs results in SCM2 becoming the master of the CSB subsystem, then SCM2 asserts its master ownership signal to its OCP and the previous slave OCP becomes the primary OCP of the system. If a master SCM detects that its OCP fails, it may de-assert its master ownership signal and promote a re-election among the remaining SCMs for master of the CSB subsystem. If the SCM cannot detect the failure, the OCP can be manually (physically) removed by an operator detecting failure of the OCP. Physical removal of the OCP causes the SCM to de-assert its ownership signal for the CSB bus and prompt a re-election for master ownership of CSB subsystem.

The electrical interface between the SCMs and the OCP is based on conventional EIA-RS232E signal levels. The EIA-RS232E interface is used for transporting display data and all discretes needed to meet the OCP cable length requirements while providing good filtering and noise immunity. As noted, all signals (except signals that are etch only) are isolated at the OCP ports 850 via the conventional opto-isolator circuits 920 to eliminate any potential ground loops caused by the independent power sources for the SCMs and OCP. All inputs received at the ports 850 from the SCMs are isolated and then multiplexed (by multiplexer 860) based on which port has ownership of the OCP 810.

The OCP selects an SCM 560 coupled to one of its ports 850 as the OCP master port by way of port arbitration election rules. The port arbitration procedure is a multistep process that involves handshaking between the SCMs and the OCP logic. As a result of this process, the OCP selects not only which SCM controls the OCP but also which SCM becomes master of the CSB subsystem 400. The master SCM of the CSB subsystem must be capable of sensing positions of the keyswitch 1100 for security and safety purposes.

Broadly stated, each SCM 560 that is coupled to the OCP sends an EIA-RS232 signal to the port to which it is connected and, if the OCP is present on its port 850, a return RS232 signal is provided to the SCM from that OCP port. This return signal is needed by the SCM to determine whether it is capable of vying for master (ownership) of the CSB bus 410. If the signal is not returned from the OCP port (an open state), the SCM detects this state and knows that it cannot attempt ownership of the CSB bus because it does not have an OCP attached to it. Thus, at least one SCM must be connected to an OCP in the SMP system, unless the OCP is dual-ported and two SCMs are connected to it.

Once an SCM is aware of its connection to the OCP, it sends another signal to the OCP indicating that it is functional and has passed self-test. The SCMs then elect (among themselves) a master of the CSB subsystem. Once the election has been performed, the elected master sends a signal to the OCP informing the OCP that it is the master of the CSB subsystem 400. At this point, the OCP has sufficient information to decide which of its ports 850 coupled to the SCM should control the OCP display 820 and LEDs 840. That is, once the information is provided by the SCMs to the OCP, the OCP decides which SCM controls the OCP 810.

More specifically, each SCM provides two input signals to the OCP: an SCM Master signal (over the Pn SCM master line 852) and an SCM Active signal (over the Pn SCM active line 854). The SCM Master signal indicates to the OCP that it is already master of the CSB subsystem. The SCM active signal indicates to the OCP that there is a cabled, powered working SCM connected to the input port. Due to the EIA signal levels, an uncabled port results in the input signals assuming unasserted states. If a single port realizes an SCM Active signal, that port “wins” ownership. If both ports have SCM Active signals and one of the ports is already master of the CSB, that port wins ownership; otherwise Port 0 (P0) is given ownership. When the selected OCP master SCM becomes unavailable, control is switched to the redundant port, if available.

FIG. 10 is a table 1000 illustrating various cases for rendering an OCP master determination in accordance with the present invention. The first case 1010 is illegal because both SCM ports (P0 and P1) claim to be masters of the CSB subsystem at the same time. As a result, the OCP ignores the assertions by these SCM ports. In the second case 1020, the SCM coupled to port P0 asserts that it is the master, whereas the SCM coupled to port P1 does not assert mastership; accordingly, the SCM coupled to P0 is elected the master OCP. In the third case 1030, the SCM coupled to P0 does not assert mastership but the SCM coupled to P1 does and, as a result, the latter SCM (coupled to P1) is elected is the master OCP. A fourth case 1040 is one in which neither P0 nor P1 assert their master ownership of the CSB subsystem. However, the SCM coupled to P0 asserts its active line while the SCM coupled to P1 does not assert its active line. Therefore, the SCM coupled to P0 becomes the OCP master of the slave OCP. In the fifth case 1050, only the SCM coupled to P1 asserts its active line, so it becomes master of the slave OCP. Finally, in the sixth case 1060, neither of the SCMs asserts the master or active lines, and thus it may be determined that there is no SCM coupled to the OCP.

In order to provide an arrangement that allows two SCMs to communicate with the OCP in an electrically isolated manner, the OCP arrangement 800 includes a novel keyswitch 1100. According to this aspect of the invention, the keyswitch has unique contact arrangements and capabilities that support fault tolerance within the switch and that support two independent remote SCMs capable of reading the switch positions. The OCP keyswitch 1100 is preferably dual-ported, providing four separate circuits for power on and secure modes for each SCM. In addition, the keyswitch provides switch positions without any power applied to the OCP, maintains electrical isolation between the two remote SCMs to eliminate ground loops and system noise, and allows key removal for security.

FIG. 11 is a schematic block diagram of the keyswitch 1100 having a 4-pole/3-position mechanism, 30° indexing, and make-before-break shorting which provides four separate and electrically isolated circuits to allow two independent SCMs to read the keyswitch position simultaneously. That is, the keyswitch has four separate poles that enable three different mechanical positions: an on position, an off position and a secure position. When the keyswitch is in the off position, the SMP system is (and remains) powered off. In addition, there is no power applied to the OCP although, as described herein, the SCM is still able to read the position of the keyswitch. When the keyswitch is in the on position, the SMP system is powered and may respond to remote system management commands via the modem port to power on or power off the system. In the secure position, the computer is powered but the buttons on the OCP are disabled and remote management access via the modem port is disabled.

Specifically, if the switch is in the on position, an SCM (e.g., SCM1) sends an EIA-RS232 signal to the keyswitch 1100 where a first pole routes that signal back to SCM1. A second pole in the switch returns an EIA-RS232 signal issued by another SCM (e.g., SCM2) if the switch is in the on position. Similarly, there are two additional sets of signals that flow to the switch and notify the SCMs if the switch is in the secure position. Thus, four signal wires (paths) are used for communication between each SCM and the keyswitch (two forward signals and two return signals). Each path through the switch 1100 is independent and each SCM sends a signal through each of its two forward paths in order to determine whether the switch is in the on, off or secure position. Depending upon whether the signals are returned (or assume open states), each SCM can detect the position of the keyswitch independently and with total electrical isolation before power is applied to the OCP.

For example, SCM1 sends an EIA-RS232 signal to the switch to detect whether the switch is in the on position. If the signal is not returned and in fact the pole is in the open position then SCM1 detects an open state. Similarly, SCM1 will send an EIA-RS232 signal to the keyswitch over the secure line and if the pole is in the open position SCM1 will detect an open state. Therefore, if the keyswitch is not in the on or secure positions, it is in the off position and power is not applied to the system. Furthermore, if the switch is in the on position and the signal applied to the secure position is open, the system is in the on state. If both the on and secure signals are returned to the SCM, the SCM senses a secure state (position) of the keyswitch. This novel design is needed to maintain isolation between each of the SCMs and between the SCMs and the OCP, and to enable sensing by the SCMs when no power is applied to the OCP.

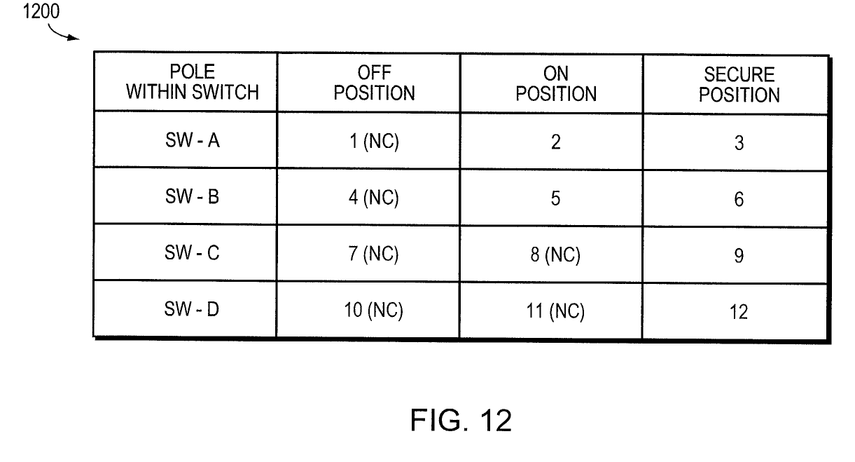

FIG. 12 is a table 1200 illustrating the states of the keyswitch poles with respect to the off, on and secure positions of the switch. According to the table, index 0 denotes the off position, index 1 is the on position and index 2 is the secure position. SW-A, SW-B, SW-C and SW-D are the four poles, each of which rotates through the 3 positions for a total of 12 contact positions. It should be noted that contacts 2 to 3 and 5 to 6 are shorted within the switch 1100 to ensure the make-before-break operation.

Assume SCM1 sends an EIA-232 (SPACE) level to SW-A and receives an EIA-232 signal back from contact 2/3. If the keyswitch 1100 is in the off position or if the OCP cable is not attached, SCM1 receives a MARK. If the switch 1100 is in the on or secure position, SCM1 receives a SPACE. Similarly, SCM2 sends an EIA-232 (SPACE) level to SW-B and receives an EIA-232 signal back from contact 5/6. If the keyswitch 1100 is in the off position or if the OCP cable is not attached, SCM2 receives a MARK and if the switch is in the on or secure position, SCM2 receives a SPACE.

Assume also that SCM1 sends an EIA-232 (SPACE) level to SW-C and receives an EIA-232 signal back from contact 9. If the keyswitch is in the off or on position, or if the OCP cable is not attached, SCM1 receives a MARK. If the switch is in the secure position, SCM1 receives a SPACE. Similarly, SCM2 sends an EIA-232 (SPACE) level to SW-D and receives an EIA-232 signal back from contact 12. If the keyswitch 1100 is in the off or on position, or if the OCP cable is not attached, SCM2 receives a MARK. If the switch is in the secure position, SCM2 receives a SPACE.

Advantageously, the novel keyswitch 1100 provides fault-tolerance in that two SCMs may determine the position of the switch simultaneously. No OCP power is required to read the switch positions; all switch debounce and filtering is provided at the SCM received end. Electrical isolation is achieved since each SCM sends and receives an EIA-232 signal loop through independent poles within the switch. The EIA-232 signaling allows the SCMs to be greater than 10 meters from the physical switch. This enables the redundant SCMs in the SMP system to provide power-on, power-off and secure control of the power subsystem.

Moreover, the dual-ported OCP arrangement supports a comprehensive redundant system control management approach for a distributed computer system. Since the SCM controls the CSB management subsystem, redundant SCM capability is needed for high availability. Allowing two SCMs to access a primary OCP supports redundant SCM operation and supports multiple SCM/OCPs for further high availability. In addition, the use of multiple dual-ported OCPs is particularly useful for a computer system that supports partitioning.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A dual-ported operator control panel (OCP) arrangement of a distributed computer system comprising:
a plurality of OCPs, each OCP comprising a plurality of ports coupled to a display, light emitting diodes (LEDs) and push buttons via a multiplexer;
a plurality of microprocessors, each coupled to an OCP port; and
OCP election logic coupled to the OCP ports and multiplexer, the OCP election logic configured to select a microprocessor coupled to an OCP port to control the display and LEDs of the OCP, the OCP election logic further enabling the multiplexer to allow the selected microprocessor to control the display and LEDs.

2. The dual-ported OCP arrangement of claim 1 wherein the push buttons comprises halt, reset and fault state buttons and wherein the LEDs comprises power OK, halt and secure states.

3. The dual-ported OCP arrangement of claim 2 wherein the states of the buttons are provided to OCP ports over separate isolated data paths of the OCP.

4. The dual-ported OCP arrangement of claim 1 wherein each OCP further comprises a keyswitch having a 4-pole/3-position mechanism with 30° indexing.

5. The dual-ported OCP arrangement of claim 4 wherein the keyswitch further comprises make-before-break shorting that provides a plurality of separate and electrically isolated circuits to allow the microprocessors access to read the position of the keyswitch simultaneously.

6. The dual-ported OCP arrangement of claim 1 wherein the distributed computer system is a symmetric multiprocessor (SMP) system having a management subsystem comprising a network of microcontrollers, and wherein the microprocessors are system control manager (SCM) microcontrollers of the SMP system.

7. The dual-ported OCP arrangement of claim 3 wherein the microprocessors are interconnected by a console serial bus (CSB) subsystem.

8. The dual-ported OCP arrangement of claim 7 wherein
the microprocessors negotiate among themselves to elect a master of the CSB subsystem, and
the elected master microprocessor asserts a mastership signal to the OCP to which the elected master microprocessor is coupled.

9. The dual-ported OCP arrangement of claim 8 wherein the OCPs elect a single OCP to be master OCP based on signals received by the OCPs from the microprocessors coupled thereto.

10. The dual-ported OCP arrangement of claim 9 wherein a given OCP is elected the master OCP provided that a single microprocessor coupled to the given OCP asserts the mastership signal, thereby indicated that the respective microprocessor is master of the CSB subsystem.

11. The dual-ported OCP arrangement of claim 10 wherein a given OCP is designated a slave OCP where no microprocessor coupled to the given OCP asserts the mastership signal.

12. The dual-ported OCP arrangement of claim 11 wherein the assertion of the mastership signal by more than microprocessor coupled to the same OCP is ignored by the OCP.

13. The dual-ported OCP arrangement of claim 12 further comprising an OCP master determination table accessible by the OCP election logic for use in determining whether the respective OCP is the master or a slave OCP.

14. The dual-ported OCP arrangement of claim 13 wherein the microprocessors and OCPs utilize the EIA-RS232E specification standard.
